(19) United States
(12) Patent Application Publication
(10) Pub. No.: US 2024/0296582 A1
(43) Pub. Date: Sep. 5, 2024

(54) POSE RELATION TRANSFORMER AND REFINING OCCLUSIONS FOR HUMAN POSE ESTIMATION

(71) Applicant: Purdue Research Foundation, West Lafayette, IN (US)

(72) Inventors: Karthik Ramani, West Lafayette, IN (US); Hyung-gun Chi, West Lafayette, IN (US); Seunggeun Chi, West Lafayette, IN (US)

(21) Appl. No.: 18/584,191

(22) Filed: Feb. 22, 2024

Related U.S. Application Data
(60) Provisional application No. 63/487,728, filed on Mar. 1, 2023.

(51) Int. Cl. G06T 7/73; G06V 10/26; G06V 10/44

(52) U.S. Cl. CPC G06T 7/73; G06V 10/26; G06V 10/44; G06T 2207/20044; G06T 2207/20084

(57) ABSTRACT

An approach for pose estimation is disclosed that can mitigate the effect of occlusions. A POse Relation Transformer (PORT) module is configured to reconstruct occluded joints given the visible joints utilizing joint correlations by capturing the implicit joint occlusions. The PORT module captures the global context of the pose using self-attention and a local context by aggregating adjacent joint features. To train the PORT module to learn joint correlations, joints are randomly masked and the PORT module learns to reconstruct the masked joints, referred to as Masked Joint Modeling (MJM). Notably, the PORT module is a model-agnostic plug-in for pose refinement under occlusion that can be plugged into any existing or future keypoint detector with substantially low computational costs.

This application claims the benefit of priority of U.S. provisional application Ser. No. 63/487,728, filed on Mar. 1, 2023 the disclosure of which is herein incorporated by reference in its entirety.

### GOVERNMENT LICENSE RIGHTS

This invention was made with government support under contract number DUE1839971 awarded by the National Science Foundation. The government has certain rights in the invention.

### FIELD

The device and method disclosed in this document relates to human pose estimation and, more particularly, to a pose relation transformer for refining occlusions for human pose estimation.

### BACKGROUND

Unless otherwise indicated herein, the materials described in this section are not admitted to be the prior art by inclusion in this section.

Human pose estimation has attracted significant interest due to its importance to various tasks in robotics, such as human-robot interaction, hand-object interaction in AR/VR, imitation learning for dexterous manipulation, and learning from demonstration. Accurately estimating a human pose is an essential task for many applications in robotics. However, existing pose estimation methods suffer from poor performance when occlusion occurs. Particularly, in a single-view camera setup, various occlusions such as self-occlusion, occlusion by an object, and being out-of-frame occur. This occlusion confuses the keypoint detectors of existing pose estimation methods, which perform an essential intermediate step in human pose estimation. As a result, such existing keypoint detectors will often produce incorrect poses that result in errors in applications such as lost tracking and gestural miscommunication in human-robot interaction.

### SUMMARY

A method for human pose estimation is disclosed. The method comprises obtaining, with a processor, a plurality of keypoints corresponding to a plurality of joints of a human in an image. The method further comprises masking, with the processor, a subset of keypoints in the plurality of keypoints corresponding to occluded joints of the human. The method further comprises determining, with the processor, a reconstructed subset of keypoints by reconstructing the masked subset of keypoints using a machine learning model. The method further comprises forming, with the processor, a refined plurality of keypoints based on the plurality of keypoints and the reconstructed subset of keypoints. The refined plurality of keypoints is used by a system to perform a task.

### BRIEF DESCRIPTION OF THE DRAWINGS

The foregoing aspects and other features of the methods are explained in the following description, taken in connection with the accompanying drawings.

FIG. 1 summarizes a workflow for human pose estimation that is robust against joint occlusion.

FIG. 2 shows exemplary hardware components of a pose estimation system.

FIG. 3 shows a logical flow diagram for a method for human pose estimation.

FIG. 4 shows an occlusion refinement architecture employed by the pose estimation system and method.

FIG. 5 illustrates the improved accuracy of the refined keypoints provided by the pose relation transformer.

FIG. 6 shows a Masked Joint Modeling (MJM) strategy that is used for training the pose relation transformer.

FIG. 7 shows a keypoint detection performance comparison for various keypoint detectors with and without the pose relation transformer.

FIGS. 8A-8E show error distribution over different confidence values with and without the pose relation transformer on five test datasets.

### DETAILED DESCRIPTION

For the purposes of promoting an understanding of the principles of the disclosure, reference will now be made to the embodiments illustrated in the drawings and described in the following written specification. It is understood that no limitation to the scope of the disclosure is thereby intended. It is further understood that the present disclosure includes any alterations and modifications to the illustrated embodiments and includes further applications of the principles of the disclosure as would normally occur to one skilled in the art which this disclosure pertains.

### Overview

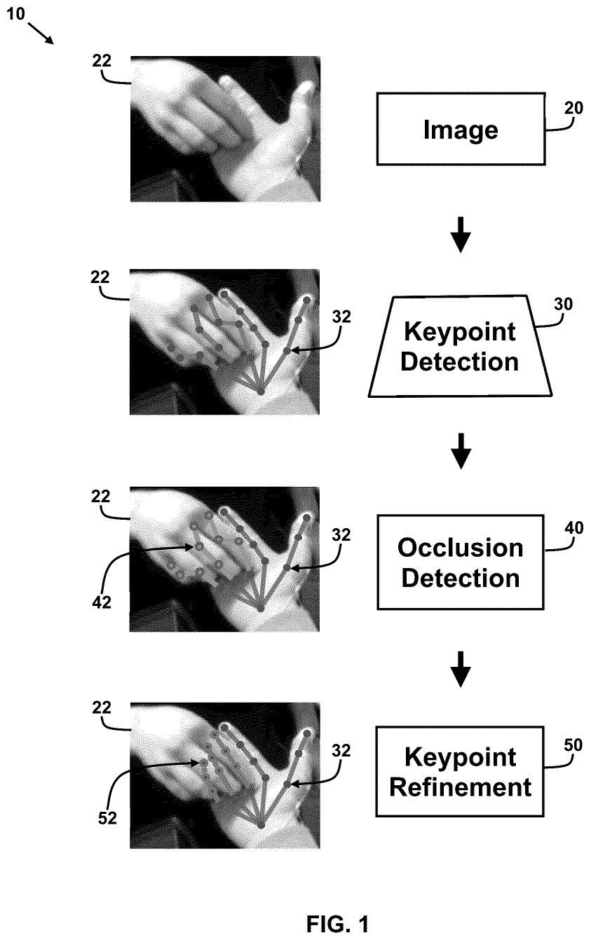

FIG. 1 summarizes a workflow 10 for human pose estimation that is robust against joint occlusion. The workflow 10 advantageously operates on top of any existing keypoint detection method in a model-agnostic manner to refine keypoints corresponding to joints under occlusion. It should be appreciated that the workflow 10 may be incorporated into a wide variety of systems that require human pose estimation to be performed, such as a robotics system, an augmented/virtual/mixed reality system, or similar systems. The workflow 10 advantageously employs a novel approach to mitigate the effect of occlusions, which is a persistent problem with existing pose estimation methods.

In a first phase (block 20), an image is received that includes a human, such as an image 22 of a hand. Next, in a second phase (block 30), a plurality of keypoints 32 corresponding to joints of the human are determined using a keypoint detection model. The processing of these first two phases can be performed by any existing or future keypoint detection model. Next, in a third phase (block 40), an occluded subset 42 of the plurality of keypoints 32 are identified. Finally, in a fourth phase (block 50), the occluded subset 42 are masked and reconstructed using a machine learning model to derive a refined occluded subset 52.

For the purpose of refining the keypoints corresponding to occluded joints (block 50), the workflow 10 advantageously leverages Masked Joint Modeling (MJM) to mitigate the effect of occlusions. Particularly, the estimation system 100 incorporates a pose relation transformer that captures the global context of the pose using self-attention and a local context by aggregating adjacent joint features. The pose relation transformer reconstructs the occluded joints based on the visible joints and utilizing joint correlations to capture the implicit joint occlusions.

It should be appreciated that the pose relation transformer has several advantages that makes it adaptable to existing keypoint detectors. Firstly, the pose relation transformer mitigates the effects of occlusions to provide a more reliable solution for the human pose estimation task. Specifically, the pose relation transformer improves the keypoint detection accuracy under occlusion, which is an important intermediate step for most human pose estimation methods.

Additionally, the pose relation transformer is advantageously a model-agnostic plug-in for pose refinement under occlusion that can be leveraged in conjunction with any existing keypoint detector with very low computational costs. Particularly, the pose relation transformer is configured to receive predicted locations of occluded joints from existing keypoint detectors and provides refined locations of occluded joints. The pose relation transformer is light-weight since the input format of the pose relation transformer is a joint location instead of an image. With only a small fraction (e.g., 5%) of the parameters of an existing keypoint detector, the pose relation transformer significantly reduces (e.g., up to 16%) errors compared to the existing keypoint detector alone.

Lastly, the pose relation transformer does not require additional end-to-end training or finetuning after being combined with an existing keypoint detector. Instead, the pose relation transformer is pre-trained using MJM and is plug-and-play with respect to any existing keypoint detector. To train the pose relation transformer to learn joint correlations, joints are randomly masked and the pose relation transformer is guided to reconstruct the randomly masked joints, which is referred to herein as Masked Joint Modeling (MJM). Through this process, the pose relation transformer learns to capture joint correlations and utilizes them to reconstruct occluded joints based on existing joints. In application, the trained pose relation transformer is used to refine occluded joints by reconstruction when combined with an existing keypoint detectors. Occluded joints in keypoint detectors tend to have lower confidence and higher errors. Therefore, the refinement provided by the pose relation transformer improves the detection accuracy by replacing these joints with the reconstructed joints.

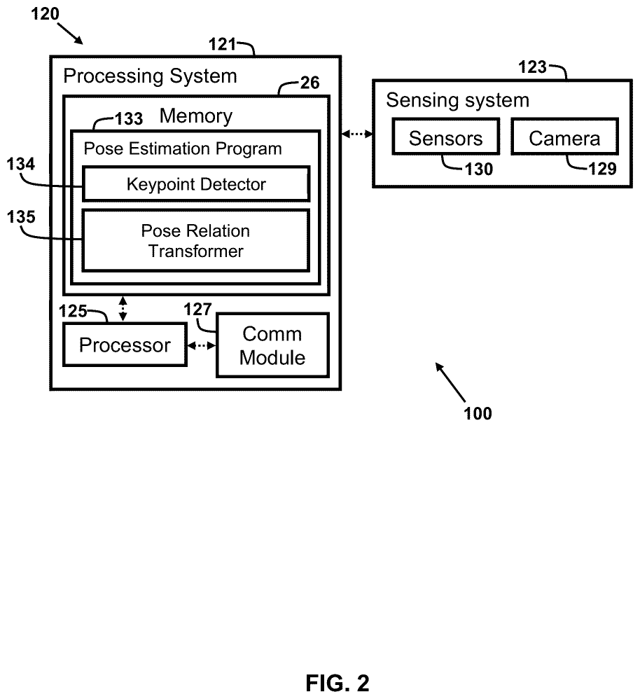

FIG. 2 shows exemplary hardware components of a pose estimation system 100. In the illustrated embodiment, the pose estimation system 100 includes a processing system 120 and a sensing system 123. It should be appreciated that the components of the processing system 120 shown and described are merely exemplary and that the processing system 120 may comprise any alternative configuration. Moreover, in the illustration of FIG. 2, only a single processing system 120 and a single sensing system 123 is shown. However, in practice the pose estimation system 100 may include one or multiple processing systems 120 or sensing systems 123.

In some embodiments, the processing system 121 may comprise a discrete computer that is configured to communicate with the sensing system 123 via one or more wired or wireless connections. However, in alternative embodiments, the processing system 121 is integrated with the sensing system 123. Moreover, the processing system 121 may incorporate server-side cloud processing systems.

The processing system 121 comprises a processor 125 and a memory 126. The memory 126 is configured to store data and program instructions that, when executed by the processor 125, enable the processing system 120 to perform various operations described herein. The memory 126 may be any type of device capable of storing information accessible by the processor 125, such as a memory card, ROM, RAM, hard drives, discs, flash memory, or any of various other computer-readable media serving as data storage devices, as will be recognized by those of ordinary skill in the art. Additionally, it will be recognized by those of ordinary skill in the art that a “processor” includes any hardware system, hardware mechanism or hardware component that processes data, signals or other information. The processor 125 may include a system with a central processing unit, graphics processing units, multiple processing units, dedicated circuitry for achieving functionality, programmable logic, or other processing systems.

The processing system 121 further comprises one or more transceivers, modems, or other communication devices configured to enable communications with various other devices. Particularly, in the illustrated embodiment, the processing system 121 comprises a communication module 127. The communication module 127 is configured to enable communication with a local area network, wide area network, and/or network router (not shown) and includes at least one transceiver with a corresponding antenna, as well as any processors, memories, oscillators, or other hardware conventionally included in a communication module. The processor 125 may be configured to operate the communication module 127 to send and receive messages, such as control and data messages, to and from other devices via the network and/or router. It will be appreciated that a variety of wired and wireless communication technologies can be utilized to enable data communications, such as Wi-Fi, Bluetooth, Z-Wave, Zigbee, or any other communication technology.

In the illustrated exemplary embodiment, the sensing system 123 comprises a camera 129. The camera 129 is configured to capture a plurality of images of the environment, each of which comprises a two-dimensional array of pixels. Each pixel has corresponding photometric information (intensity, color, and/or brightness). In some embodiments, the camera 129 is configured to generate RGB-D images in which each pixel has corresponding photometric information and geometric information (depth and/or distance). In such embodiments, the camera 129 may, for example, take the form of two RGB cameras configured to capture stereoscopic images, from which depth and/or distance information can be derived, or an RGB camera with an associated IR camera configured to provide depth and/or distance information. In light of the above, it should be appreciated that the keypoint detection model of the system 100 may utilize images having both photometric and geometric data to estimate joint locations.

In some embodiments the sensing system 123 may be integrated with or otherwise take the form of a head-mounted augmented reality or virtual reality device. To these ends, the sensing system 123 may further comprise a variety of sensors 130. In some embodiments, the sensors 130 include sensors configured to measure one or more accelerations and/or rotational rates of the sensing system 123. In one embodiment, the sensors 130 include one or more accelerometers configured to measure linear accelerations of the sensing system 123 along one or more axes (e.g., roll, pitch, and yaw axes) and/or one or more gyroscopes configured to measure rotational rates of the sensing system 123 along one or more axes (e.g., roll, pitch, and yaw axes). In some embodiments, the sensors 130 include LIDAR or IR cameras.

The program instructions stored on the memory 126 include a pose estimation program 133. As discussed in further detail below, the processor 125 is configured to execute the pose estimation program 133 to determine keypoints of human joints and to refine those keypoints. To this end, the pose estimation program 133 includes a keypoint detector 134 and a pose relation transformer 135. Particularly, the processor 125 is configured to execute the keypoint detector 134 to determine keypoints of human joints for the purpose of pose detection, and execute the pose relation transformer 135 to refine the determined keypoints to improve accuracy under occlusion scenarios.

### Methods for Pose Estimation Using a Pose Relation Transformer

A variety of methods, workflows, and processes are described below for enabling more accurate human pose estimation using the POse Relation Transformer (PORT). In these descriptions, statements that a method, workflow, processor, and/or system is performing some task or function refers to a controller or processor (e.g., the processor 125) executing programmed instructions (e.g., the pose estimation program 133, the keypoint detector 134, the pose relation transformer 135) stored in non-transitory computer readable storage media (e.g., the memory 126) operatively connected to the controller or processor to manipulate data or to operate one or more components in the pose estimation system 100 to perform the task or function. Additionally, the steps of the methods may be performed in any feasible chronological order, regardless of the order shown in the figures or the order in which the steps are described.

The methods employed by the pose estimation system 100 aim to refine the occluded joints estimated from a keypoint detector using the pose relation transformer. The pose relation transformer captures both the global and local context of the pose, providing clues to infer occluded joints. Specifically, the pose relation transformer utilizes graph convolution to extract local information and feeds extracted features to self-attention to capture global joint dependencies. To guide the pose relation transformer 135 to reconstruct occluded joints from captured joint relations, the training process leverages Masked Joint Modeling (MJM), which is the task of reconstructing randomly masked joints. The pose relation transformer 135 combined with the keypoint detector 134 and refines the joints produced by the keypoint detector 134.

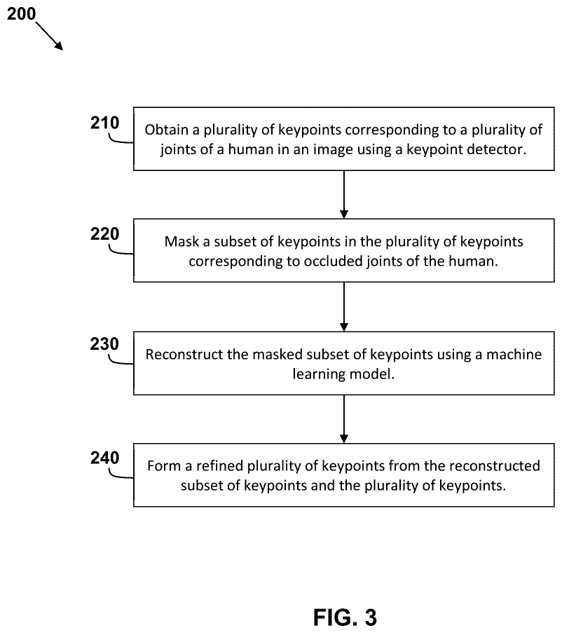

FIG. 3 shows a logical flow diagram for a method 200 for human pose estimation. The method 200 advantageously leverages Masked Joint Modeling (MJM) to mitigate the effect of occlusions in human pose estimation. Particularly, the method 200 incorporates a POse Relation Transformer (PORT) that captures the global context of the pose using self-attention and the local context by aggregating adjacent joint features. Using the pose relation transformer, the method 200 reconstructs occluded joints given the visible joints utilizing joint correlations by capturing the implicit joint occlusions.

The method 200 begins with obtaining a plurality of keypoints corresponding to a plurality of joints of a human in an image using a keypoint detector (block 210). Particularly, the processor 125 obtains a plurality of keypoints [symbol] corresponding to a plurality of joints of a human in a respective image, such as by reading the plurality of keypoints [symbol] from the memory 126, receiving the plurality of keypoints [symbol] from an external source via the communication module 127, or by determining the plurality of keypoints [symbol] using a keypoint detector. In at least some embodiments, the processor 125 receives the image from an image sensor, such as the camera 129, and determines the plurality of keypoints [symbol] by executing the keypoint detector 134 with respect to the received image. In some embodiments, the processor 125 generates a plurality of heatmaps [symbol] based on the image and determines the plurality of keypoints [symbol] based on the plurality of heatmaps [symbol] , where each respective joint is determined based on a corresponding respective heatmap. In at least one embodiment, the processor 125 further determines a plurality of confidence values [symbol] for the plurality of keypoints [symbol] based on the plurality of heatmaps [symbol] , where each respective confidence value is determined based on a corresponding respective heatmap.

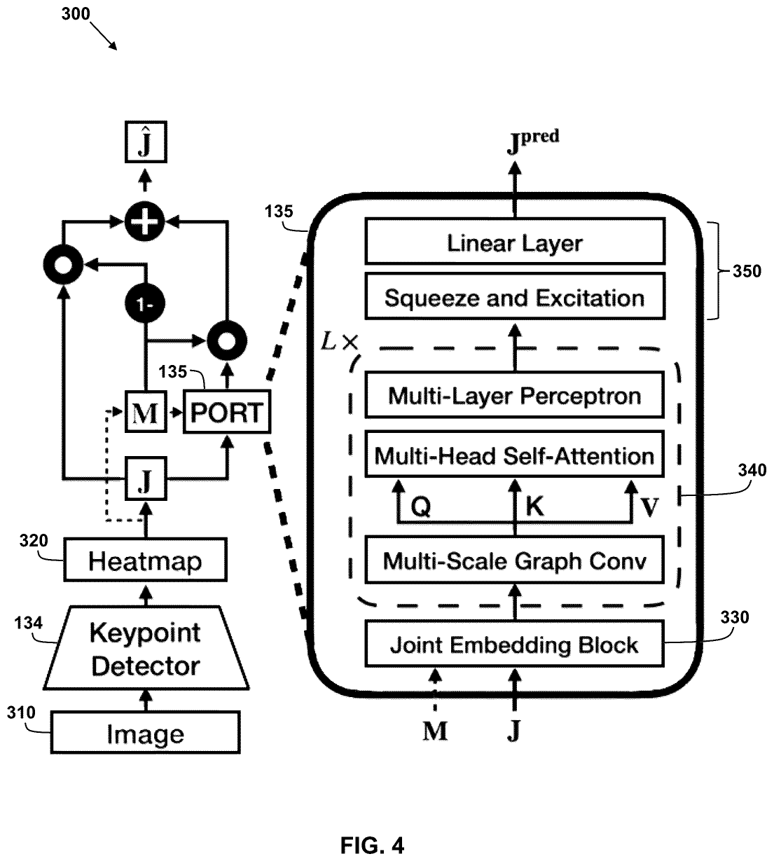

FIG. 4 shows an occlusion refinement architecture employed by the pose estimation system 100 and by the method 200. Firstly, the processor 125 receives an image 310 from an image sensor, such as the camera 129 of the sensing system 123. Next, the processor 125 executes the keypoint detector 134 to determine the plurality of N keypoints

$$𝒥 = {\{ {J}_{n} \}}_{n = 1}^{N}$$

corresponding to a plurality of joints of a human captured in the image 310. In some embodiments, the processor 125 executes the keypoint detector 134 to first determine a plurality of N heatmaps 320, denoted

$$ℋ = {\{ {H}_{n} \}}_{n = 1}^{N} ,$$

from the image 310 and derive the plurality of keypoints [symbol] from the plurality of heatmaps [symbol] . Particularly, the processor 125 calculates a joint location of an n-th joint Jₙ based on a corresponding heatmap [symbol] ₙ. In one embodiment, the processor 125 determines each joint jₙ using the argmax function argmax_{(i,j)} [ [symbol] ₙ]_{i,j}, where (i, j) are two-dimensional image coordinates in the heatmap [symbol] ₙ and/or the image 310. Alternatively, in some embodiments, the processor 125 determines each joint Jₙ using a weighted sum after applying a soft-argmax operation to the heatmaps, according to:

$${J}_{n} = ( {x}_{n} , {y}_{n} ) ( {\sum }_{i}^{W} {\sum }_{j}^{H} {i [ {H}_{n} ]}_{i , j} , {\sum }_{i}^{W} {\sum }_{j}^{H} {j [ {H}_{n} ]}_{i , j} ) , \qquad ( 1 )$$

where W is an image width of the heatmap [symbol] ₙ and/or the image 310 and H is an image height of the heatmap [symbol] ₙ and/or the image 310.

In at least some embodiments, the processor 125 also derives a plurality of confidence values

$$𝒞 = {\{ {c}_{n} \}}_{n = 1}^{N}$$

from plurality of heatmaps [symbol] . Particularly, the processor 125 determines each confidence value cₙ according to:

$${c}_{n} = {[ {H}_{n} ]}_{⌊ {x}_{n} ⌉ , ⌊ {y}_{n} ⌉} , \qquad ( 2 )$$

where

$$0 \leq {c}_{n} \leq 1 ⌊ ⁃ ⌋$$

denotes a round operation.

Returning to FIG. 3, the method 200 continues with masking a subset of keypoints in the plurality of keypoints corresponding to occluded joints of the human (block 220). Particularly, the processor 125 determines a subset of keypoints from the plurality of keypoints [symbol] that correspond to occluded joints of the human. In at least some embodiments, the processor 125 determines a masking vector [symbol] ∈ [symbol] ^{N×1} having indices of the subset of keypoints to be masked in [symbol] .

It can be observed that estimated joints from the keypoint detector 134 tend to have low confidence under occlusion, leading to high pose estimation error. Thus, in some embodiments, the processor 125 determines the subset of keypoints to be masked, based on the plurality of confidence values [symbol] , as those keypoints Jₙ in the plurality of keypoints [symbol] having respective confidence values cₙ that that are less than a predefined threshold δ. In at least some embodiments, the processor 125 determines the masking vector [symbol] to identify those keypoints Jₙ from the keypoint detector 134 for which the confidence value [symbol] is less than the predefined threshold δ, as follows:

$${m}_{n} = \{ \begin{matrix}1 & if {c}_{n} < δ \\ 0 & otherwise .\end{matrix} \qquad ( 3 ) .$$

Next, the method 200 continues with reconstructing the masked subset of keypoints using a machine learning model (block 230). Particularly, the processor 125 determines a reconstructed subset of keypoints by reconstructing the masked subset of keypoints using a machine learning model. In one embodiment, the machine learning model is configured to take the plurality of keypoints [symbol] as inputs and output a plurality of reconstructed keypoints J^{pred}. In some embodiments, the machine learning model is configured to also take the masking vector [symbol] as an input. In at least some embodiments, the machine learning model is, in particular, a pose relation transformer 135, which has an encoder with a Transformer-based neural network architecture.

With reference again to FIG. 4, the detailed architecture of the Pose Relation Transformer 135 is described. After the keypoint detector 134 is used to determine the plurality of keypoints [symbol] and the masking vector [symbol] , the plurality of keypoints [symbol] , and in some embodiments the masking vector [symbol] , are passed to the pose relation transformer 135. The pose relation transformer 135 consists of a joint embedding block 330, an encoder 340, and a regression head 350. As discussed in greater detail below, the architecture of the pose relation transformer 135 advantageously leverages Multi-Scale Graph Convolution (MSGC) in both the joint embedding block 330 and in the encoder 340. Additionally, the architecture of the pose relation transformer 135 advantageously leverages Masked Joint Modeling (MJM) and a Transformer-based neural network architecture in the encoder 340

In the joint embedding block 330, the pose relation transformer 135 transforms the joint features to an embedding dimension using MSGC and uses it as input for the encoder 340. Particularly, the processor 125 determines an initial set of feature embeddings Z₍₀₎ based on the plurality of keypoints [symbol] using MSGC. The pose relation transformer 135 uses graph convolution for the embedding process so as to better capture the semantic knowledge embedded in the plurality of keypoints [symbol] . Graph representations have been widely adopted to model the human skeleton because of its versatility in capturing physical constraints, relations, and semantics of the skeleton. Graph convolution is an effective method to extract skeleton features since the human skeleton can be represented as a graph with joints as nodes and bones as edges. Graph convolution enables the pose relation transformer 135 to extract the local context.

For a better understanding of the architecture of the pose relation transformer 135, MSGC is preliminarily described in general terms. Let a C-dimensional node feature matrix be X∈ [symbol] ^{N×C} and an adjacency matrix be a binary matrix A∈ [symbol] ^{N×N}, where A_{i,j} is 1 if i-th and j-th joins are connected with a bone otherwise 0. Then, graph convolution is formulated as Ã^{k}XW, where Ã is a symmetrically normalized form of A+I, I denotes the identity matrix, and W∈ [symbol] ^{C×C′} are learnable weights. Similarly, a Multi-Scale Graph Convolution (MSGC) MSGC is formulated as:

$$MSGC ( A , X ) = \frac{1}{\vert 𝒦 \vert} {\sum }_{k ∈ 𝒦} {\tilde{A}}^{k} XW , \qquad ( 4 )$$

where [symbol] is a set of exponents for the adjacency matrix A.

Using a similar formulation in the joint embedding block 330, the processor 125 determines the initial feature embeddings Z₍₀₎ based on the plurality of keypoints [symbol] using MSGC. Particularly, let J∈ [symbol] ^{N×D}^{ₒ} be a skeleton joint feature matrix describing the plurality of keypoints [symbol] . The processor 125 determines the initial feature embeddings Z₍₀₎ using MSGC, in a manner that that aggregates skeleton features with different kernel sizes, according to:

$${Z}_{( 0 )} = MSGC ( A , J ) , \qquad ( 5 )$$

where Jᵢ=jᵢ and Z₍₀₎∈ [symbol] ^{N×D} is the initial set of feature embeddings, having dimensions N×D, which were determined by the joint embedding block 330 and provided to encoder 340.

It should be appreciated that, unlike in a conventional Transformer, the joint embedding block 330 does not add positional encoding for positional information since the graph convolution employs an adjacency matrix, which implicitly includes positional information. Additionally, it should be appreciated that the joint embedding block 330 omits non-linear activation since graph convolution is used for feature projection and embedding.

With continued reference to FIG. 4, the encoder 340 advantageously leverages Masked Joint Modeling (MJM) and adopts a Transformer that is similar to those introduced in Masked Language Modeling (MLM). The Transformer's self-attention mechanism captures the pose's global context. For a better understanding of the architecture of the pose relation transformer 135, MLM is preliminarily described. The objective of MLM is to train a model to predict masked words in a sentence. During the training, the words in a sentence are randomly masked, and the model predicts the masked words by learning the correlations between the words. Let

$$𝒲 = {\{ {w}_{n} \}}_{n = 1}^{T}$$

denotes the sequence of words, and [symbol] denotes a set of masked word indices. The objective of MLM is to maximize the log-likelihood of masked word wᵢ conditioned on visible words [symbol] ᵥᵢₛ which are not masked, according to:

$$\frac{1}{\vert ℳ \vert} {\sum }_{i ∈ ℳ} log p ( {w}_{i} \vert {W}_{v i s} ) . \qquad ( 6 )$$

The encoder 340 has a Transformer-based neural network architecture with and ordered sequence of L encoding layers. The encoder 340 is built based on the Transformer encoder and is configured to capture the global and local context of the pose using self-attention and graph convolution, respectively. To further utilize the semantic knowledge embedded in the skeleton, the architecture of the pose relation transformer 135 also uses graph convolution for the projection process of the Transformer. Thus, the encoder 340 captures the context of the pose utilizing self-attention and graph convolution.

The encoder 340 receives the initial feature embeddings Z₍₀₎ and determines a plurality of attended feature embeddings {Z₍ₗ₎}=ₗ₋₁^{L}. In each case, Z₍ₗ₎∈ [symbol] ^{N×D} indicates a set of feature embeddings output by a l-th encoding layer of the encoder 340 and having dimensions N×D. The processor 125 determines the plurality of attended feature embeddings {Z₍ₗ₎}ₗ₋₁^{L} based on the initial feature embeddings Z₍₀₎, using the encoder 340. Each set of attended feature embeddings Z₍ₗ₎ is determined and output by a respective encoding layer (i.e., the l-th encoding layer) based on the set of attended feature embeddings Z₍ₗ₋₁₎ output by the previous encoding layer. However, with respect to the first encoding layer of the encoder 340, the first set of attended feature embeddings Z₍ₗ₎ is determined based on the initial feature embeddings Z₍₀₎, as there is no previous encoding layer.

In each encoding layer of the encoder 340, to embed the local context, the processor 125 determines a respective multi-head self-attention matrix based on the previous set of attended feature embeddings Z₍ₗ₋₁₎. First, in each encoding layer, the processor 125 determines respective Key, Query, and Value matrices based on (denoted as Q₍ₗ₎, K₍ₗ₎, V₍ₗ₎∈ [symbol] ^{N×D}, respectively) the previous set of attended feature embeddings Z₍ₗ₋₁₎ using MSGC, according to:

$${Q}_{( l )} , {K}_{( l )} , {V}_{( l )} = MSGC ( A , {Z}_{( l - 1 )} ) . \qquad ( 7 )$$

Next, the attention is calculated as:

$$Attention ( Q , K , V ) = Softmax ( \frac{{QK}^{T}}{\sqrt{D}} V ) . \qquad ( 8 )$$

In particular, the processer 125 determines a Multi-head Self-Attention (MSA) matrix based on the respective Q₍ₗ₎, K₍ₗ₎, V₍ₗ₎ matrices, which allows the model to explore different feature representation subspaces. Next, the processor 125 determines an intermediate feature embedding Z′₍ₗ₎ based on the respective MSA matrix and the previous set of attended feature embeddings Z₍ₗ₋₁₎. Finally, the processor 125 determines the respective set of attended feature embeddings Z₍ₗ₎ based on the intermediate feature embedding Z′₍ₗ₎ using a multi-layer perceptron (MLP). The overall encoding process of the encoding layer is formulated as:

$${Z}_{( l )}^{′} = {Z}_{( l - 1 )} + MSA ( LN ( {Z}_{( l - 1 )} ) ) , \qquad ( 9 )$$

$${Z}_{( l )} = {Z}_{( l )}^{′} + MLP ( LN ( {Z}_{( l )}^{′} ) ) , \qquad ( 10 )$$

where LN(·) denotes layer normalization. Two linear layers with ReLU activation are used for the MLP.

Lastly, the regression head 350 receives at least the final set of attended feature embeddings Z_{(L)} from the final encoding layer of the encoder 340 and projects the output of the encoder to joint locations. Particularly, the processor 125 determines a plurality of reconstructed keypoints J^{pred} based on at least the final set of attended feature embeddings Z_{(L)}, using Sequence-and-Excitation (SE) and a linear layer. To explicitly model channel inter-dependencies, the processor 125 determines an SE weight matrix according to:

$$SE ( Z ) = Sigmoid ( MLP ( \frac{1}{N} {\sum }_{i}^{N} {Z}_{i} ) ) , \qquad ( 11 )$$

where the output SE(Z)∈ [symbol] ^{1×D} is a weight matrix for the respective channel.

Finally, the processor 125 determines a plurality of reconstructed keypoints J^{pred} based on the SE weight matrix SE(Z_{(L)}), the final set of attended feature embeddings Z_{(L)}, and a linear projection weight matrix W′. The entire decoding process is defined as:

$${J}^{pred} = ( SE ( {Z}_{( L )} ) ⊙ {Z}_{( L )} ) {W}^{′} , \qquad ( 12 )$$

where ⊙ denotes the broadcasted element-wise product and W′∈ [symbol] ^{D×D}^{₀} is the linear projection weight matrix.

Finally, returning to FIG. 3, the method 200 continues with forming a refined plurality of keypoints from the reconstructed subset of keypoints and the plurality of keypoints (block 230). Particularly, the processor 125 forms a refined plurality of keypoints Ĵ by substituting the reconstructed subset of keypoints in place of the masked keypoints in the plurality of keypoints [symbol] . In particularly, the processor 125 uses the masking vector [symbol] to substitute reconstructed keypoints from the plurality of reconstructed keypoints J^{pred} only in place of the masked keypoint keypoints in the plurality of keypoints [symbol] , while retaining the non-masked, high-confidence, keypoints in the plurality of keypoints [symbol] . This process can be summarized as:

$$\hat{J} = ( 1 - ℳ ) ⊙ 𝒥 + ℳ ⊙ {J}^{pred} , \qquad ( 13 )$$

By refining the keypoints having low confidence, overall performance of the pose estimation process can be improved. As noted before, the pose relation transformer 135 is added as a plug-in to an existing keypoint detector 134 and, thus, can be used to refine the estimated keypoints from any existing or future keypoint detector 134, based on their confidence values.

FIG. 5 illustrates the improved accuracy of the refined keypoints provided by the pose relation transformer 135. Particularly, on the left, a set of original keypoints 400 provided by the keypoint detector 134 are illustrated. On the right, a set of refined keypoints 410 provided after reconstruction by the pose relation transformer 135 are illustrated. As can be seen, the refined keypoints 410 provide a much more plausible set of keypoints for those joints that were occluded (off-screen) in the original image 420.

It should be appreciated that, after generating the refined plurality of keypoints Ĵ, the pose estimation system 100 may utilize the refined plurality of keypoints Ĵ to perform a task. Such tasks may include any task that utilizes keypoint detection, such as robotics, augmented reality, virtual reality, motion capture, and any similar application for which accurate human pose estimation is required or useful.

In some examples, the pose estimation system 100 is integrated with an augmented reality or virtual reality device. The augmented reality or virtual reality device may perform tasks that require hand or body tracking of the user and other people around the user. For example, the augmented reality or virtual reality device may display augmented reality or virtual reality graphical user interfaces that provide functions and features depending on hand or body tracking, such as displaying certain graphical elements in response to detecting particular hand-object interactions. Such hand-object interactions would be detected on the basis of the plurality of refined keypoints provided by the pose estimation system 100.

In further examples, the pose estimation system 100 is integrated with a robotics system. The robotics system may perform tasks that require hand or body tracking of people around the robotics system. For example, the robotics system may perform certain operations or motions in the physical environment depending on hand or body tracking, such as performing a collaborative operation in response to the human performing a corresponding motion or gesture. Such human-robot interactions and collaborations would be enabled using the plurality of refined keypoints provided by the pose estimation system 100 to detect the corresponding motions or gestures of the human.

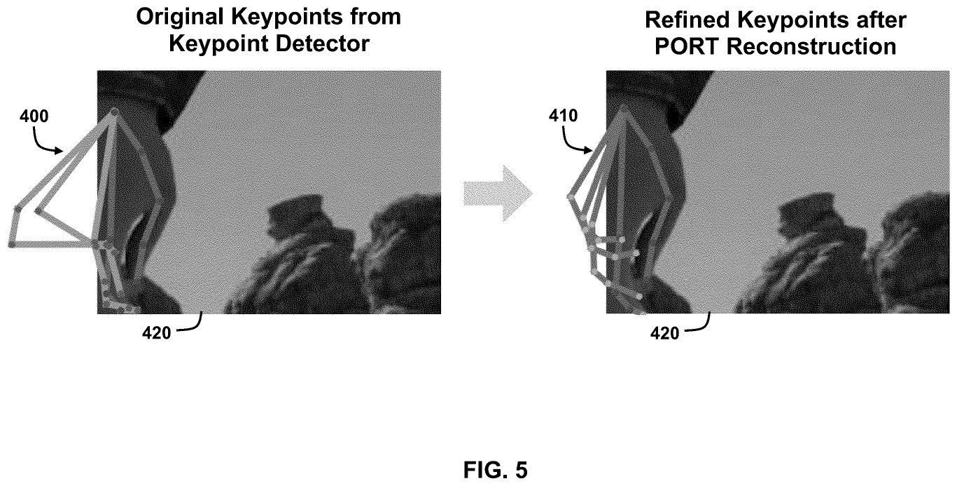

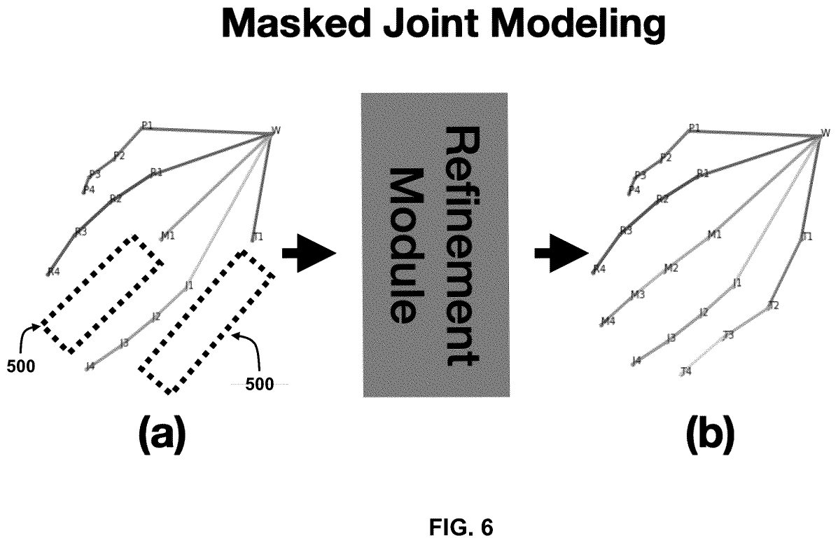

FIG. 6 shows a Masked Joint Modeling (MJM) strategy that is used for training the pose relation transformer 135. Particularly, prior to deploying the system 100 for human pose estimation, the pose relation transformer 135 must be trained. The objective of MJM is to reconstruct masked joints given visible joints. A training dataset is provided that includes, in each training sample, a plurality of keypoints corresponding to joints of a human. During training, joint indices are randomly selected and masked 500 from the plurality of keypoints in each training sample, using a masking matrix [symbol] . The pose relation transformer 135 (refinement module) is trained to predict or reconstruct the masked joints. In an alternative embodiment, rather than masking the input joints, corresponding rows of joint embedding Z₍₀₎ are replaced with a learnable mask embedding E^{mask}∈ [symbol] ^{1×D}. To train the pose relation transformer 135, the target distribution of an i-th joint is set to follow two dimensional gaussian [symbol] ᵢ(μᵢ, σᵢI) with a ground truth joint location as a center μᵢ=Jᵢ^{GT} and a fixed variance σᵢ=1. Then, the pose relation transformer 135 is trained to minimize reconstruction loss [symbol] , defined as a negative gaussian log-likelihood, according to:

$$ℒ = \frac{1}{\vert ℳ \vert} {\sum }_{i ∈ ℳ} \frac{{‖ {J}_{i}^{pred} - {μ}_{i} ‖}_{2}^{2}}{{σ}_{i}^{2}} = {\sum }_{i ∈ ℳ} \frac{{‖ {J}_{i}^{pred} - {J}_{i}^{GT} ‖}_{2}^{2}}{\vert ℳ \vert} . \qquad ( 14 )$$

### Improved Performance in Human Pose Estimation

Extensive experiments were conducted to demonstrate that the pose relation transformer 135 mitigates occlusion effects on hand and body pose estimations. Particularly, to demonstrate the effectiveness of the pose relation transformer 135 in refining occluded joints, the pose relation transformer 135 was evaluated on four datasets that cover various occlusion scenarios. It is shown that the pose relation transformer 135 improves the performance of existing keypoint detectors. The pose relation transformer 135 improves the pose estimation accuracy of existing human pose estimation methods up to 16% with only an additional 5% of parameters, compared to the existing keypoint detectors alone.

To demonstrate the effectiveness of the pose relation transformer 135 under occlusion, the keypoint detection task was carried out by adding the pose relation transformer 135 to existing keypoint detectors. To cover various occlusion scenarios, the pose relation transformer 135 was tested on four datasets:

FPHB Dataset—The First-Person Hand action Benchmark (FPHB) dataset is a collection of egocentric videos of hand-object interactions. This dataset was selected to explore the scenario of self-occlusion and occlusion by the object. The action-split of FPHB was used in the experiments.

CMU Panoptic Dataset—The CMU Panoptic dataset contains third-person view hand images. This dataset was selected to test the pose relation transformer 135 to various scenarios in third-person view images.

RHD Dataset—The Rendered Hand pose Dataset (RHD) contains rendered human hands and their keypoints, which comprised 41,258 training and 2,728 testing samples.

H36M Dataset—The Human 3.6M dataset (H36M) contains 3.6 million human poses. The pose relation transformer 135 was trained with five subjects (1, 5, 6, 7, 8) and tested with two subjects (9, 11). However, images on H36M are not much occluded since they are recorded on single-person action in the indoor environment. Therefore, to simulate the occlusion scenario, an additional test set was introduced, called H36_masked, by synthesizing occlusion with a random mask patch following. In this test set, synthetic masks are randomly colored 30×30 pixel-sized square centered on the joint. The patches were generated for each joint following binomial distribution B(n=17, p=0.02).

The results were evaluated using two metrics, End Point Error (EPE) and Procrustes analysis End Point Error (P-EPE). EPE quantifies the pixel differences between the ground truth and the predicted results. P-EPE quantifies the pixel differences after aligning the prediction with the ground truth via a rigid transform. P-EPE was used for all analysis since it properly reflects occlusion refinement by measuring the pose similarity.

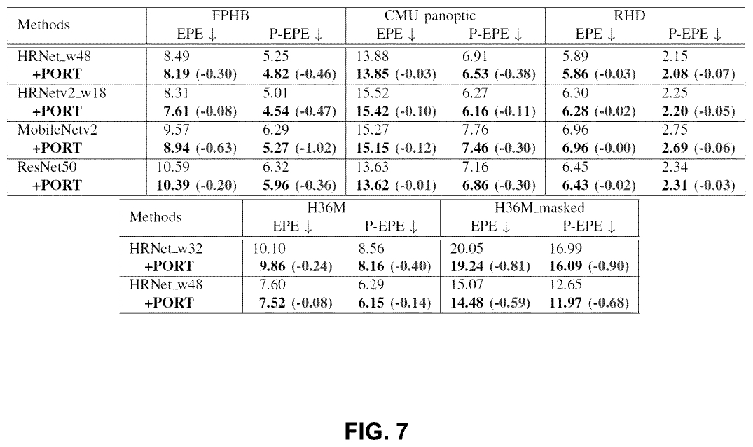

FIG. 7 shows a keypoint detection performance comparison for various keypoint detectors with and without the pose relation transformer 135. The top portion of the table includes hand test sets. The bottom portion of the table includes human body test sets. Bold figures indicate the results with the pose relation transformer 135, with the improvement noted in parentheses. The effect of the pose relation transformer 135 was investigated on various keypoint detectors including: HRNet, HRNetv2, MobileNetv2, ResNet, and using the test datasets mentioned above. In the table, the error of estimated joints [symbol] from the pretrained keypoint detectors and refined joints Ĵ from the pose relation transformer 135 are compared. It was observed that the pose relation transformer 135 reduces the errors of all keypoint detectors under different test sets in terms of both MPJPE and P-EPE. It was also found that P-EPE improvements are more significant than MPJPE over all results. This result implies that the pose relation transformer 135 tends to refine the results into plausible poses, rather than fix each joint into the exact location.

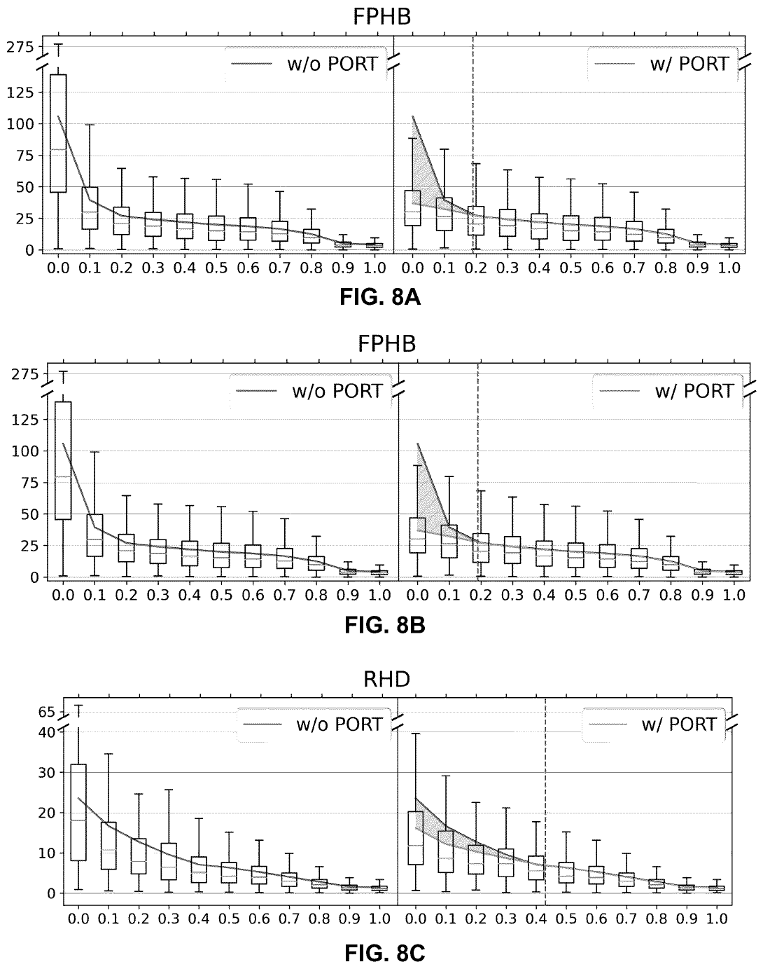

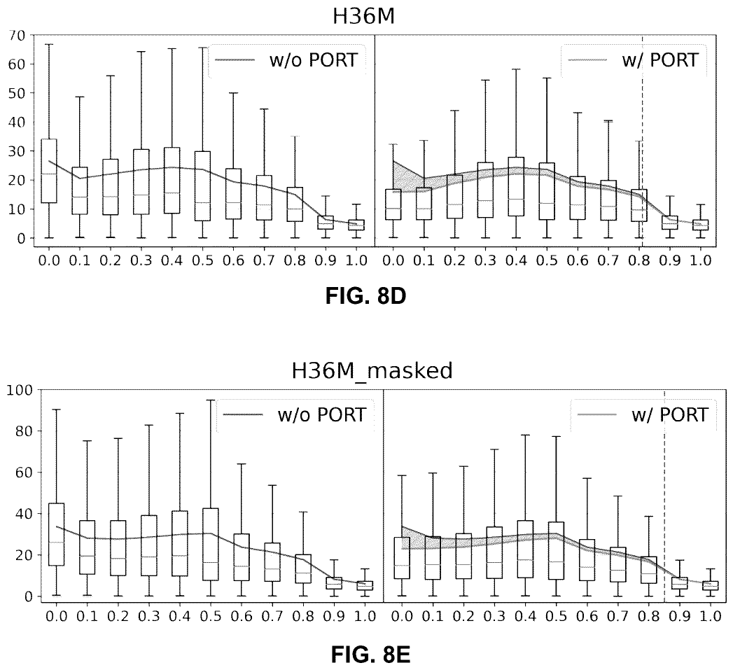

The effectiveness of the pose relation transformer 135 on occlusion was analyzed using the experimental results of the keypoint detector HRNet w48. FIGS. 8A-8E show error distribution over different confidence values (Left) without and (Right) with the pose relation transformer 135 on the five test datasets. The vertical dashed lines indicate each test set's confidence threshold δ. The shaded area highlights the error reduction by the pose relation transformer 135. The plots show the error distribution with and without the pose relation transformer 135 on the five test datasets to see the effect of the pose relation transformer 135 on different confidence values. The distribution is visualized using box plots by grouping joints based on their confidence values. Lines connect the mean values of each box on different confidence values. These lines (without the pose relation transformer 135) are duplicated on the right plot for easy comparisons. It is observed that the error distribution with confidence less than δ (vertical dashed lines), which is assumed to be occlusion, reduced over all test sets. It is also noted that the lower the confidence, the greater the effect of the pose relation transformer 135. These results demonstrate that the pose relation transformer 135 reduces the error by successfully refining the low-confidence joints.

Embodiments within the scope of the disclosure may also include non-transitory computer-readable storage media or machine-readable medium for carrying or having computer-executable instructions (also referred to as program instructions) or data structures stored thereon. Such non-transitory computer-readable storage media or machine-readable medium may be any available media that can be accessed by a general purpose or special purpose computer. By way of example, and not limitation, such non-transitory computer-readable storage media or machine-readable medium can comprise RAM, ROM, EEPROM, CD-ROM or other optical disk storage, magnetic disk storage or other magnetic storage devices, or any other medium which can be used to carry or store desired program code means in the form of computer-executable instructions or data structures. Combinations of the above should also be included within the scope of the non-transitory computer-readable storage media or machine-readable medium.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

While the disclosure has been illustrated and described in detail in the drawings and foregoing description, the same should be considered as illustrative and not restrictive in character. It is understood that only the preferred embodiments have been presented and that all changes, modifications and further applications that come within the spirit of the disclosure are desired to be protected.

What is claimed is:

1. A method for human pose estimation comprising:
obtaining, with a processor, a plurality of keypoints corresponding to a plurality of joints of a human in an image;
masking, with the processor, a subset of keypoints in the plurality of keypoints corresponding to occluded joints of the human;
determining, with the processor, a reconstructed subset of keypoints by reconstructing the masked subset of keypoints using a machine learning model; and
forming, with the processor, a refined plurality of keypoints based on the plurality of keypoints and the reconstructed subset of keypoints, the refined plurality of keypoints being used by a system to perform a task.

2. The method according to claim 1, the obtaining the plurality of keypoints further comprising:
receiving, with the processor, the image from an image sensor, the image capturing the human; and
determining, with the processor, the plurality of keypoints corresponding to the plurality of joints of the human using a keypoint detection model.

3. The method according to claim 2, the determining the plurality of keypoints further comprising:
generating, with the processor, a plurality of heatmaps based on the image; and
determining, with the processor, the plurality of keypoints based on the plurality of heatmaps, each respective joint in the plurality of keypoints being determined based on a corresponding respective heatmap in the plurality of heatmaps.

4. The method according to claim 3 further comprising:
determining, with the processor, a plurality of confidence values for the plurality of keypoints based on the plurality of heatmaps, each respective confidence value being determined based on a corresponding respective heatmap in the plurality of heatmaps.

5. The method according to claim 1, the masking the subset of keypoints further comprising:
obtaining, with the processor, a respective confidence value for each keypoint in the plurality of keypoints; and
determining, with the processor, the subset of keypoints as those keypoints in the plurality of keypoints having respective confidence values that are less than a predetermined threshold.

6. The method according to claim 1, wherein the machine learning model incorporates a Transformer-based neural network architecture and uses multi-scale graph convolution.

7. The method according to claim 1, the determining the reconstructed subset of keypoints further comprising:
determining, with the processor, an initial feature embedding based on the plurality of keypoints.

8. The method according to claim 7, the determining the initial feature embedding further comprising:
determining the initial feature embedding using multi-scale graph convolution.

9. The method according to claim 7, the determining the reconstructed subset of keypoints further comprising:
determining, with the processor, based on the initial feature embedding, a plurality of attended feature embeddings using an encoder of the machine learning model, the encoder having a Transformer-based neural network architecture.

10. The method according to claim 9, wherein the encoder has a plurality of encoding layers, the plurality of encoding layers having a sequential order, each respective encoding layer determining a respective attended feature embedding of the plurality of attended feature embeddings.

11. The method according to claim 10, the determining the plurality of attended feature embeddings further comprising:
determining, with the processor, each respective attended feature embedding of the plurality of attended feature embeddings, in a respective encoding layer of the plurality of encoding layers, based on a previous feature embedding,
wherein (i) for a first encoding layer of the plurality of encoding layers, the previous feature embedding is the initial feature embedding and (ii) for each encoding layer of the plurality of encoding layers other than the first encoding layer, the previous feature embedding is that which is output by a previous encoding layer of the plurality of encoding layers.

12. The method according to claim 11, the determining each respective attended feature embedding further comprising:
determining, with the processor, a respective attention matrix based on the previous feature embedding; and
determining, with the processor, the respective attended feature embedding based on the attention matrix and the previous attended feature embedding.

13. The method according to claim 12, the determining the respective attention matrix further comprising:
determining, with the processor, a respective multi-head self-attention matrix.

14. The method according to claim 12, the determining the respective attention matrix further comprising:
determining, with the processor, respective Key, Query, and Value matrices based on the previous feature embedding; and
determining, with the processor, the respective attention matrix based on the previous feature embedding and the respective Key, Query, and Value matrices.

15. The method according to claim 14, the determining the respective attention matrix further comprising:
determining, with the processor, the respective Key, Query, and Value matrices using multi-scale graph convolution.

16. The method according to claim 12, the determining each respective attended feature embedding further comprising:
determining, with the processor, a respective intermediate feature embedding based on the attention matrix and the previous attended feature embedding; and
determining, with the processor, the respective attended feature embedding based on the respective intermediate feature embedding using a multi-layer perceptron.

17. The method according to claim 10, the determining the reconstructed subset of keypoints further comprising:
determining, with the processor, the reconstructed subset of keypoints based on a final attended feature embedding of the plurality of attended feature embeddings, the final attended feature embedding being output by a final encoding layer of the plurality of encoding layers.

18. The method according to claim 17, the determining the reconstructed subset of keypoints further comprising:
determining, with the processor, the reconstructed subset of keypoints based on the final attended feature embedding using sequence-and-excitation.

19. The method according to claim 1, the forming the refined plurality of keypoints further comprising:
forming, with the processor, a refined plurality of keypoints by substituting the reconstructed subset of keypoints in place of the masked subset of keypoints in the plurality of keypoints.

20. The method according to claim 1, wherein the machine learning model has been previously trained by randomly masking keypoints in a training dataset and learning to predict the masked keypoints.
